(19) United States
(12) Patent Application Publication
(10) Pub. No.: US 2007/0133598 A1
(43) Pub. Date: Jun. 14, 2007

(54) System and method for determining position of communicating devices

(76) Inventor: Patrick Moran, Shrewsbury, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/299,456

(22) Filed: Dec. 12, 2005

(51) Int. Cl. H04J 3/16

(52) U.S. Cl. 370/466; 370/328

(57) ABSTRACT

The present invention determines distances between wireless sensor and computing nodes in a mesh computer or other network. The invention utilizes a set of sinusoidal waves, each being a multiple of a base frequency. The waves are transmitted from a first node to a second node. The second node determines the phase of the waves at the time of the zero-crossing in the first node. The distance between the nodes is determined based upon the phases. The waves may be sent as rotations of a quadrature signal.

### BACKGROUND OF THE INVENTION

1. Field of the Invention

The present invention relates to a wireless sensor network and mesh computer having a plurality of elements which communicate with each other. More particularly, it relates to the design and operation of computing nodes within the mesh for determining distances and positions between said nodes.

2. Discussion of Related Art

A wireless sensor mesh network is formed from a densely deployed collection of unreliable distributed sensors and nodes with limited bandwidth, memory and computational capabilities connected in a mesh network layout. A characteristic of a mesh network is that it is constrained by its energy resources, is self-organizing and fault tolerant. The sensor and compute nodes are usually battery powered and are operated in an unattended and inaccessible environment. Over time, as the sensors and compute nodes fail the neighboring nodes will modify their behavior so that the overall system continues to function. New sensor and compute nodes are deployed on top of the partially functional system thereby extending the performance and longevity of the system indefinitely.

To optimize the use of the network resources and to coordinate functionalty between devices, it is desirable to have the mesh nodes understand their spatial relation to each other. Specifically, the distance between nodes must be determined with some degree of accuracy. It is not practicable to physically measure the distances between nodes. Furthermore, as nodes fail and are replaced, the position of a given node with respect to their neighbors will change from time to time. Thus, a process is necessary to automatically determine the distance between nodes.

There are a number of methods that enable the mesh nodes to determine their relative position. One of these methods is to use a Received Signal Strength Indicator (RSSI) which measures the received signal from a known transmitter then, using a computational algorithm and a model of the channel loss versus the distance, compute an estimate of the spacing between the transmitter and receiver. Another method is to use a pulse of very short duration, sometimes referred to as ultrawideband (UWB) signaling, and measure the time of arrival (TOA) of the signal. Given the propagation speed of the signal and the time of arrival, the distance can be computed. Yet another method is to use an out-of-band signaling technique with two or more transmitted signals such as a low frequency radio or acoustic beacon along with a high frequency carrier. There are deficiencies with each of these various methods. In particular, they require complex structures for transmitting, receiving, and processing the necessary signals. Furthermore, such systems have significant limitations in determining distances with accuracy.

Other methods of position detection and location include, the global positioning system (GPS) is a system which uses transmissions from multiple satellites to determine the position of a receiver and LORAN. Additionally, several systems exist for determining position of cellular telephones based upon signals from cell towers. However, each of these systems requires significant computational and processing capability and consume a significant amount of energy during the computation of their location. They are not easily adapted to the desired small size and low power consumption of a mobile sensor in a mesh computer system. They also cannot be adapted to utilize existing antenna and transmissions mechanisms within the sensor. A completely separate receiver system is required for determining the position.

### SUMMARY OF THE INVENTION

The present invention overcomes many of the deficiencies of the prior art through a system and method for determining distances between two communicating devices. According to one aspect of the invention, a method for determining distance utilizes a transmitter transmitting a plurality of synchronized periodic signals, each signal having a frequency which is a multiple of a base frequency. According to an aspect of the invention, the periodic signals are sinusoidal. A receiver determines a phase of each of the signals at a synchronized time, such as the zero crossing time of sinusoidal waves at the transmitter. The receiver utilizes the phases of the signals to determine a distance from the transmitter. According to another aspect of the invention, the plurality of periodic signals are sent as a time multiplexed signal. According to another aspect of the invention, the plurality of periodic signals are superimposed on an unrelated transmission.

According to another aspect of the invention, the periodic signals are provided through rotation of the components of quadrature signals. The receiver determines the rotational phase of the signal for use in determining the distance. According to another aspect of the invention, the quadrature signal is processed to create the rotation. According to another aspect of the invention, a repeater is used to create the transmission signals. A first device transmits the periodic signals. A second device, the repeater, receives the signals and re-transmits them to the first device. A phase locked loop is used to synchronize the signals in the repeater. The first device processes the signals from the second device to determine the distance between the devices. Since the signals are synchronized in the second device, the first device can determine the zero crossing point to the signal and its phase at the time of zero crossing.

According to another aspect of the invention, a mesh system utilizes the method of the invention to determine the position of all of the devices on the mesh. Two devices (a device and its repeater) can determine absolute distance along a line of transmission. Three devices (two devices and a repeater) can determine distance in a plane. Four devices in the mesh utilize another process for determining exact position in three dimensions. The remaining devices determine their distances from the known positions of the four devices using the method of the present invention. With the known distances, the positions of all devices in the mesh are determined in three dimensional space.

### BRIEF DESCRIPTION OF THE DRAWINGS

FIG. 1 illustrates sinusoidal waves utilized to determine distances between devices according to an embodiment of the present invention.

FIG. 2 are block diagrams of two devices for determining the distance between them according to an embodiment of the present invention.

FIG. 3 is a block diagram of a repeater according to an embodiment of the present invention.

FIG. 4 is a block diagram of a system according to an embodiment of the present invention.

### DETAILED DESCRIPTION

The present invention provides a method for determining a distance between nodes in a network or mesh. The method utilizes sinusoidal radio frequency waves transmitted from one of the nodes to the other node. A single node can transmit the necessary signals as discussed below. Each node in the network, upon receiving the signals can determine its distance from the transmitting node.

The theory of operation of the method is illustrated in FIG. 1. FIG. 1 illustrates a set 10 of sinusoidal waves. The first wave 11 has a frequency which operates as a base frequency of the method. The base frequency is chosen so that the wavelength is greater than the maximum distance between any of the nodes. As illustrated in FIG. 1, the transmitting node is at position 20. An exemplary receiving node is at position 21. The receiving node 21 is able to determine the phase of the first sinusoidal wave 11 which is at the base frequency. The receiving node 21 determines the phase at a time when the transmitting node 20 is at a zero-crossing point 16 in the wave. Since the speed of propagation of the wave is a known constant, the determined phase is used to calculate a distance between the transmitting node 20 and the receiving node 21. However, the determination of the phase necessarily includes an error factor.

The potential error factor is reduced through the use of additional sinusoidal waves. The succeeding waves 12, 13, 14 are synchronized with the base wave and have frequencies which are multiples of the base frequency. According to a preferred embodiment, the frequency of each succeeding wave is twice that of the preceding wave. The receiving node 21 determines the phase of each of the succeeding waves 12, 13, 14 at the same zero-crossing point 16 for the transmitting node 20. Each phase is determined with a degree of error. As the frequency increases, the error in the phase determination represents a smaller error in the distance determination. By determining the relative phases of the waves at each of the frequencies, the distance between the transmitting node and receiving node can be accurately determined. For example, a base frequency of 100 MHz has a wavelength of approximately 3 meters. With only eight waves, the distance between nodes can be determined within approximately 0.125 meters. Additionally, since the use of successive waves reduces the error in the phase determination, depending upon the number of waves used and the desired precision of determining distances, the phase determination with respect to any particular wave can be imprecise without limiting the invention. Additional precision of the measurement can be obtained by time averaging the rotational phase and interpolating the signal. It may be sufficient to merely determine the zero-crossing points of any wave and determine whether the phase is in the first or second half of the wave.

The present invention is not limited to sinusoidal signals. The method can be used with any set of periodic signals having the frequency relationship described above. A phase of a signal can be determined for any periodic signal. Additionally, since the method of the present invention can accurately determine distances based upon simply the zero crossing points of a sinusoidal wave, it can determine the distance from periodic signals having a single pulse per period.

The method for determining the distance between nodes as set forth above does not depend upon the devices used to transmit and receive the sinusoidal waves. Furthermore, any device can be used within the receiver for determining the phase of the sinusoidal waves. Nevertheless, FIG. 2 illustrates devices for transmitting and receiving the sinusoidal waves. As illustrated in FIG. 2, a transmitter 120 includes a signal processor 121 and a quadrature antenna system 122. The quadrature antenna system 122 includes an in-phase antenna 123 and a quadrature antenna 124. Preferably, the in-phase antenna 123 and quadrature antenna 124 are orthogonal. However, non-orthogonal positioning can also be used. It is sufficient that a polar asymmetry exists in the antenna radiation pattern such that the quadrature components can be generated and detected in the transmitter and receiver. Using known methods and circuitry, the signal processor 121 generates in-phase and quadrature signals 140 at a transmission frequency. The signals 140 are respectively supplied to the in-phase 123 and quadarature 124 antennas of the quadrature antenna system 122. The sinusoidal waves 10 of the method of the present invention are generated as rotations of the in-phase and quadrature signals 140. The signal processor 121 modulates the signals to represent the rotation of the signals prior to transmission on the quadrature antenna system 122.

The receiver 130 similarly includes a quadrature antenna system 131 and a signal processor 131. At the receiver 130, the signal processor 131 operates to determine the rotational phase of the received signal. First, the signal processor sums the inputs from the in-phase and quadrature antennas. Summing the two inputs eliminates any amplitude modulation in the transmission signal and provides a stronger signal irrespective of the position of the antennas. Using known methods and circuitry, the signal processor 131 determines the rotational phase of the signal. The rotational phase represents the sinusoidal signals 10 used in determining the distance between the devices as discussed above.

The devices illustrated in FIG. 2 for transmitting and receiving the sinusoidal waves 10 have several advantages over other types of signal processing equipment. The transmitter 120, receiver 130 and their respective signal processors 121, 131 constitute only part of the devices at each node. The nodes are designed to provide communication and processing capabilities in connection with the mesh computer or other distributed system. Thus, the nodes constantly transmit and receive signals. The signals relating to determination of distances represent a very small part of the communication capability of the nodes. The operation described above regarding the signals for determining distances can operate on top of any existing communications. Quadrature antenna systems are used in nodes because they allow the transmitter to offer polarization diversity which ensures that the system will operate reliably and allow independent positioning and orientation of the transmitter and receiver. Thus, the mobile nodes would typically include a quadrature antenna system for transmission of the communication signals. Furthermore, using rotation of the quadrature signal to generate the sinusoidal waves 10 allows the system to be superimposed on existing communication signals. Thus, the distance determination process can operate at the same time that other communication between the transmitter and receiver occur.

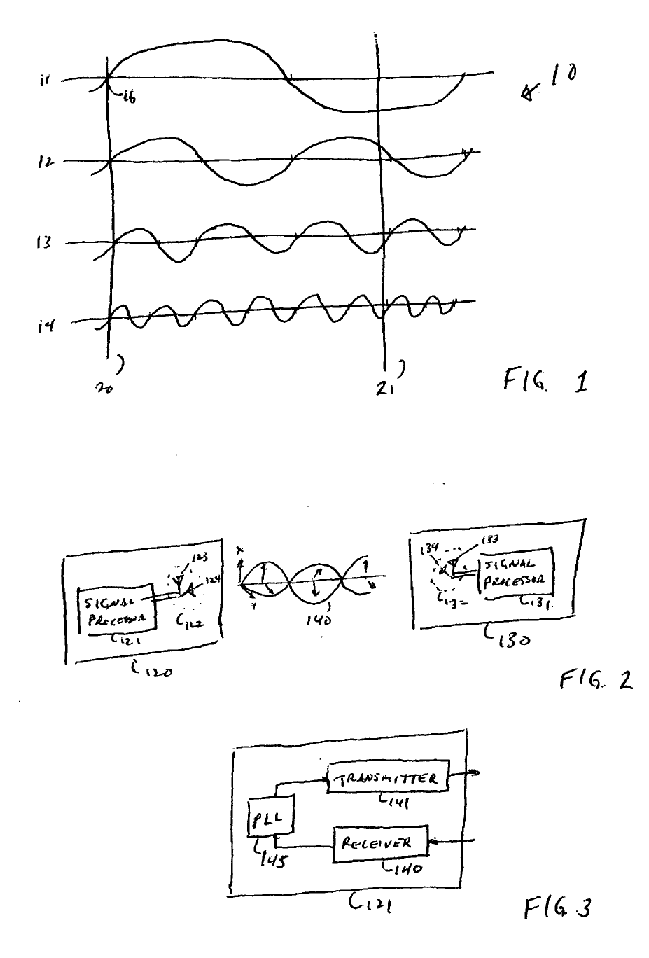

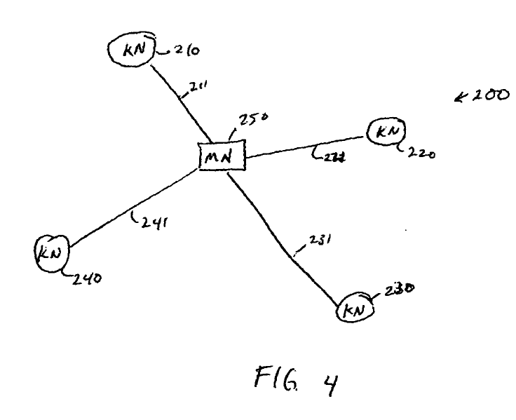

As discussed above, the receiver 21 determines the distance from the transmitter 20 based upon the phase of the sinusoidal waves 10 when the transmitter is at a zero-crossing point 16. FIG. 3 illustrates a structure of a repeater used in the transmitter 20 for allowing determination of the zero-crossing point 16 according to an embodiment of the invention. In this embodiment, the sinusoidal waves 10 are generated at the receiver 21. A signal processor at the receiver 21 generates a quadrature signal for transmission on a quadrature antenna system, as discussed above. The quadrature signal includes a rotation of the phase in accordance with the sinusoidal waves 10. The transmitter 20 includes a signal processor 121 having components as illustrated in FIG. 3. The signal processor 121 includes a receiver 140 and transmitter 141. The receiver 140 includes circuitry for determining the rotational information within the quadrature signal. The transmitter 141 includes circuitry to superimpose rotational information on a quadrature signal transmitted by the transmitter 20. A phase locked loop 145 operates to synchronize the receiver 140 and transmitter 141 within the signal processor 121. In this manner, the signal processor 121 of the transmitter 20 operates as a repeater. It transmits an identical rotational signal to that received from the receiver 21. Thus, the receiver 20 can determine the phase of the return signal when at the zero-crossing point 16 of its own transmission. The distance determined would then be twice the distance between the nodes. Furthermore, with this embodiment of the invention, the relation between the quadrature waves 10 can be time multiplexed or code multiplexed within a transmission. Since the transmitter 20 is merely a repeater, the receiver 21 can determine the multiplexing and modulation of the quadrature waves 10 from its own transmissions.

The method of the present invention can be used in conjunction with other methods for determining distanced. For example, a Received Signal Strength Indicator (RSSI) method, using known structures, can be used to estimate a distance between a transmitter and receiver. However, an RSSI method decreases in accuracy as the distance between the nodes increase. The method of the present invention can be used for greater accuracy once the distance has been estimated using the RSSI method. Such a combination would permit distances longer than the wavelength of the base frequency to be determined.

Similarly, the method of the present invention can be combined with Ultrawideband (UWB) signaling methods. The present invention utilizes periodic signals transmitted from one device to another. The nature of the signals are irrelevant to the method of the present invention. Thus, UWB signals can be used for transmitting the periodic signals.

FIG. 4 illustrates operation of the present invention in connection with determining a position of a mobile node within a mesh computer or other wireless network 200. In order to determine three dimensional position, the position of four nodes 210, 220, 230, 240 must be known. Fewer known nodes can be used if the position does not need to be determined in three dimensions. Thus, three known nodes could be used if all of the nodes are in a single plane. Two known nodes can be used to determine distances along a line. The known nodes may include an independent system for determining their position, such as a GSP system. This system would be operated for a short time at initialization or upon repositioning of the node to determine position of the known node 210, 220, 230, 240. The known nodes may also be programmed with their position if they are immobilized. Preferably, the known nodes 210, 220, 230, 240 would be at the outermost edge of the mesh or network 200. Each of the known nodes 210, 220, 230, 240 transmits as part of its communications signals its permanent position. The times and frequency of transmitting their position depends upon the desired operation of the mesh or network. They could periodically transmit the information. Alternatively, they could transmit it in response to a query by another node. Thus, when a mobile node 250 is initialized, it could request the positions of the known nodes 210, 220, 230, 240. The known nodes 210, 220, 230, 240 function as transmitters 20 in the accordance with the methods of the present invention. In particular, they operate to receive a rotating quadrature signal and repeat the rotation in a transmitted signal. The mobile node 250 operates as a receiver 21. It generates the rotating quadrature signal and receives the duplicated one. Using the method of the present invention, it determines the distances 211, 221, 231, 241 between itself and the four known nodes 210, 220, 230, 240, respectively. From the distances and the known positions of the known nodes, the mobile node 250 is able to determine its three dimensional position in the mesh or network.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A method for determining a distance between a first wireless communication device and a second wireless communication device, the method comprising the steps of:
transmitting a plurality of periodic signals from the first wireless communication device, wherein each of the plurality of signals has a frequency which is a multiple of a base frequency and wherein the plurality of signals are synchronized;
receiving the plurality of periodic signals at the second wireless communication device;
determining a phase of each of the plurality of periodic signals at a synchronized time; and
determining the distance between the first wireless communication device and the second wireless communication device based upon the determined phases of the plurality of periodic signals.

2. The method according to claim 1, wherein the plurality of periodic signals include a plurality of sinusoidal signals.

3. The method according to claim 1, wherein one of the plurality of signals has a frequency corresponding to the base frequency.

4. The method according to claim 3, wherein the plurality of periodic signals includes periodic signals having frequencies at integer powers of 2 of the base frequency.

5. The method according to claim 1, wherein the synchronized time includes a starting time of a signal at the base frequency.

6. The method according to claim 2, wherein the synchronization time includes a zero crossing time of a signal at the base frequency.

7. The method according to claim 1, wherein the transmitting steps includes transmitting the plurality of periodic signals in a time multiplexed format.

8. The method according to claim 1, further comprising the steps of:
transmitting a second plurality of periodic signals from the second wireless communication device; and
receiving the second plurality of periodic signals at the first wireless communication device; and
wherein the step of transmitting the plurality of periodic signals includes transmitting the plurality of periodic signals in phase with the received second plurality of periodic signals.

9. The method according to claim 1, wherein the plurality of periodic signals are transmitted as angular values of a signal having quadrature components.

10. The method according to claim 1, wherein the plurality of periodic signals are superimposed on communications signals between the first wireless communication device and the second wireless communication device.

11. A system for determining distances comprising:
a first wireless communication device including:
a signal generator for generating and transmitting a plurality of periodic signals, wherein each of the plurality of signals has a frequency which is a multiple of a base frequency and wherein the plurality of signals are synchronized;
a second wireless communication device including:
a receiver for receiving the plurality of periodic signals;
a signal processor for determining a phase of each of the plurality of periodic signals at a synchronized time; and
a distance processor for determining the distance between the first wireless communication device and the second wireless communication device based upon the determined phases of the plurality of periodic signals.

12. The system according to claim 1, wherein:
the second wireless communication device further includes:
a second signal generator generating and transmitting a second plurality of periodic signals, wherein each of the second plurality of signals has a frequency which is a multiple of a base frequency and wherein the second plurality of signals are synchronized;
the first wireless communication device further includes a receiver for receiving the second plurality of periodic signals; and
the signal generator of the first wireless communication device generates the plurality of periodic signals as in phase replicas of the second plurality of periodic signals.

13. A system for determining a position of a first node in a wireless network, the system comprising:
a plurality of known nodes, wherein each of the known nodes has a stored position and wherein each of the known nodes includes:
a signal generator for generating and transmitting a plurality of periodic signals, wherein each of the plurality of signals has a frequency which is a multiple of a base frequency and wherein the plurality of signals are synchronized; and
a transmitter for transmitting the stored position; and
wherein the first node includes:
a receiver for receiving the plurality of periodic signals from each of the plurality of known nodes and the transmitted stored positions;
a signal processor for determining a phase of each of the plurality of periodic signals at a synchronized time;
a distance processor for determining the distance between the first node and each of the plurality of known nodes based upon the determined phases of the plurality of periodic signals; and
a position processor for determining position based upon the received stored positions and the determined distances.

14. The system for determining position of a first node in a wireless network according to claim 13, wherein at least one of the plurality of known nodes includes a GPS system for determining a position as the stored position.

15. The system for determining position of a first node in a wireless network according to claim 13, wherein at least one of the plurality of known nodes includes an input for receiving an entered position as the stored position.
